(19) United States
(12) Patent Application Publication
(10) Pub. No.: US 2016/0279686 A1
(43) Pub. Date: Sep. 29, 2016

(54) SOIL REMEDIATION SYSTEM

(71) Applicants: Mark T. Ellis, Lehi, UT (US); Alan R. Harker, Springville, UT (US)

(72) Inventors: Mark T. Ellis, Lehi, UT (US); Alan R. Harker, Springville, UT (US)

(21) Appl. No.: 15/181,197

(22) Filed: Jun. 13, 2016

Related U.S. Application Data
(63) Continuation of application No. 14/182,205, filed on Feb. 17, 2014, now abandoned.

(51) Int. Cl. B09C 1/00; B09C 1/10

(52) U.S. Cl. CPC B09C 1/002; B09C 1/00; B09C 1/005; B09C 1/10; B09C 2101/00

(57) ABSTRACT

A system for bioremediating soil and groundwater contaminated with high substituted chlorinated hydrocarbons, such a trichloroethylene and perchloroethylene, by a strain of Ralstonia eutropha with a non-cometabolic pathway for metabolizing chlorinated hydrocarbons, and does not require induction.

### BACKGROUND

Chlorinated solvents are man-made chemicals used in numerous applications. Chlorinated solvents are very effective in dissolving oil and grease. Accordingly they are used as solvents to clean, for example, electronic components without dissolving the components, tools, ovens, and clothing. The Europe-based “Chlorine Online” information center reports a maximum 765,000 tonnes of chlorinated compounds used worldwide in 2002 (http://www.eurochlor.org/index.asp?page=204).

These chemicals, which are characterized as having chlorine ions attached to organic substrates, are ubiquitous, and nearly refractory when released to nature. Their continuing contamination of drinking water is forcing the issue of effective and timely remediation of our precious water resources. The current industry standard for treating groundwater contaminated with chlorinated solvents typically takes decades to complete. There have been reports of more effective methods, but most industrial remediation efforts continue to rely on the old, slow methods.

There are several methods that are generally used for removing contaminants, such as gasoline and other hydrocarbons. Desirable goals for remediating any contaminated soil is to (1) treat it “in-situ”, in place, (2) produce no toxic daughter-product intermediates, (3) leave harmless end products of the degradation, and (4) accomplish all of these objectives quickly and cheaply. Processes have been developed for remediation of certain contaminants that achieve these goals well enough to be a commercial success. However, applying these methods to removing chlorinated solvents has proven to be difficult or ineffective.

A problem with chlorinated solvent contamination is the specific gravity. For example, two common chlorinated solvent contaminants, Trichloroethylene (TCE), and Perchloroethylene (PCE), have a specific gravity of 1.47, and 1.63, respectively. When these chemicals get into an aquifer, being more dense than water they flow to the bottom of the aquifer where it is very difficult to apply remediation, in particular an in-situ method.

A class of prior-art approaches that has been reported as effective for removing chlorinated solvents includes adding treatment chemicals to water aquifers. The problem with this approach that these introduce another compound, which is itself a contaminant, to an already impaired resource, and thus do not solve the problem by freeing the resource from contamination.

Other approaches involve pumping the contamination to the surface for treatment. This removes chlorinated solvents, but smear zones remain on the saturated soil that take years to treat.

Bacterial remediation methods for removing various hydrocarbon materials by anaerobic and aerobic bacterial metabolism are widely available, but application of these methods to chlorinated solvents has been difficult and problematic. Anaerobic systems involve anaerobic bacteria that can metabolize chlorinated solvents by reductive chlorination under anaerobic conditions to produce non-chlorinated hydrocarbons. These systems can involve the withdrawal and/or injection of methane and hydrogen. However, the rate of remediation is slow, and the withdrawn product gas stream contains a hydrocarbon gas and hydrogen, which is an explosive gas that requires special handling. In addition, the dechlorination is usually incomplete resulting in accumulation of, for example, trichloroethene, dichloroethene isomers, and/or vinyl chloride.

A problem with removing chlorinated solvents using bacterial metabolism under aerobic conditions is that chlorinated solvents, particularly highly substituted hydrocarbons, are not very bioavailable and are not readily aerobically metabolized by soil organisms. Highly substituted chlorinated solvents are in an oxidized state and have little or no energy availability for micro-organisms. Basically, soil organisms have been shown to metabolize a wide range of toxic chemicals, including those with chlorine substituents, because the organisms can derive energy from these chemicals. However, because many substituted chlorinated hydrocarbons, are in an advanced oxidized state and provide little or no energy benefit to an organism, these compounds are not recognized by microorganisms and left unmetabolized.

An approach to overcome this problem is to exploit the ability of some organisms to cometabolize chlorinated hydrocarbons. An organism may produce an enzyme to metabolize a compound that incidentally will metabolize chlorinated hydrocarbons. The organism will not produce the enzyme by exposure to the contaminant alone, as the catabolic pathway the produces the enzyme is not triggered. What is required is induction by exposure of the bacteria to a compound (primary substrate) that triggers the pathway. This then produces the enzyme to metabolize the primary substrate and incidentally the chlorinated hydrocarbon contaminant, the secondary substrate. The primary substrate must always be present to keep the pathway functioning. Even after the pathway has been triggered, presence of the secondary substrate alone is not sufficient to maintain the enzyme production and metabolism of the secondary substrate.

An example of the cometabolism approach is a system by CL Solutions (http://www.cl-solutions.com/). The system relies on two naturally occurring unmodified Pseudomonas species have been found and cultivated into a commercial product for aerobic, chlorinated solvent metabolism. This approach relies on cometabolism, where metabolism of the chlorinated solvent (the secondary substrate) depends on the presence of certain hydrocarbons (the primary substrate). For example the naturally occurring Pseudomonas stutzeri OX, in the process of metabolizing methane, propane or simple sugars, e.g. dextrose (primary substrate) produce monooxygenase, an enzyme that degrades chlorinated solvents, such as perchloroethylene and trichloroethylene (secondary substrate). Induction of the bacteria with the primary substrate is required, before the bacterium produces the monooxygenase.

The limitation of this approach is that the primary substrate must be present, and when the primary substrate is exhausted, the process stops, whether or not secondary substrate has been fully consumed. This often requires that a primary substrate be introduced and maintained, which is problematic if the primary substrate is also a contaminant in its own right.

In addition, the bacteria can only be present and spread in the contaminated water and soil where the primary substrate is also present in sufficient amounts. If the primary substrate does not flow into the contaminated area, there can be no remediating metabolism there. In many contaminated regions, residual organic contaminants are retained in soil pores as immobile globules or ganglia, which are difficult or impossible to reach with a mobile phase of primary substrate. The result is these untreated, chlorinated residues are left in the subsurface.

Until the 1990s an aerobic bacteria that can oxidize directly trichloroethylene (TCE) without cometabolic induction was not known, until such was developed from Ralstonia eutropha JMP134. The bacterium was reported to aerobically degrade chlorinated solvents. The strain is identified as Ralstonia eutropha AEK301/pYK3021. (AEK301/pyk3021). AEK301/pyk3021 is derived from strain as Ralstonia eutropha AEKK301, which is a Tn5 induced mutant that has lost phenol hydroxylase activity, which was derived from strain jmp134. Plasmid pYK3021 encoding phenol hydroxylase was subcloned into pMMB67EH (vector from pJP4) and exhibited TCE degradation capability without phenol induction. Triparental mating was used transfer plasmid pYk3021 an E. coli library back to R. eutropha AEK301 with the helper plasmid prK2013. The recombinant strain AEK301/pyk3021 expressed phenol hydroxylase activity constitutively and degraded TCE efficiently.

See Ayoubi, Patricia J. and Alan R. Harker, Whole-Cell Kinetics of Trichloroethylene Degradation by Phenol Hydroxylase in a Ralstonia eutropha JMP134 Derivative, Applied and Environmental Microbiology, Vol. 64, No. 11, November 1998, p. 4353-4356:

Youngjun Kum, Patricia Ayoubi, and Alan R. Harker, Constitutive Expression of the Cloned Phenol Hydroxylase Genes(s) from Alcaligenes eutrophus JMP134 and Concomitant Trichloroethylene Oxidation, Applied and Environmental Microbiology, Vol. 62, No. 9, September 1996, p. 3227-3233: and

Alan R. Harker and Young Kim, Trichloroethyylene Degradation by Two Independent Aromatic-Degrading Pathways in Alcaligenes eutrophus Jmp 134, Applied and Environmental Microbiology, Vol. 56, No. 4, April 1990, p. 1179-1181. (Harker papers)

### SUMMARY

Strains of aerobic bacterium, Ralstonia eutropha (R. eutropha) are known to degrade trichloroethylene through cometabolism mechanism. For example R. eutropha JMP134 expresses a catabolic pathway that is induced by phenol, which is broken down by production of phenol hydroxylase enzyme, which secondarily breaks down trichloroethylene.

It has been shown in the Harker papers that R. eutropha strain AEK301/pyk3021 (Strain '021) under carefully controlled laboratory conditions effectively grows and is able to degrade significant amounts of trichloroethelene in the absence of induction from aromatics, or any other substance. An aspect involves a method for introducing Strain '021 into a contaminated soil environment in which chlorinated hydrocarbons are degraded and removed.

In the laboratory Strain '021 has been cultured under otherwise sterile conditions, with optimum nutrition, pH, and temperature conditions, but no attempts have been made under field conditions. In general, the transfer of an artificial bacterial organism grown in the lab to the field does not often meet with success. There are several factors that might prevent any bacterial organism artificially introduced in to a contaminated soil environment from surviving and proliferating. Even assuming the organism will survive under the less-than-ideal conditions, the soil already supports an ecosystem of naturally occurring bacteria that are well adapted to there survive, grow and proliferate. Any newly introduced inhabitant must compete for resources, nutrition, oxygen, and importantly space, and survive predation from other organisms. A new organism that might be less robust in any way than the indigenous organisms, may not survive.

In addition, for the organism to be effective in remediation, it must not only survive, but thrive and proliferate throughout the contaminated soil matrix. A problem in systems where organisms are introduced, is that the organism may grow and thrive at and near the injection site, but do not migrate and extend their population throughout the extent of the contaminated soil.

Factors that affect survival, growth, and proliferation vary considerably from site to site, and many are unknown. Accordingly, an attempt to introduce any foreign or genetically modified bacterium into an existing contaminated environment is not likely to be met with successful survival, growth and proliferation.

It has been found that Strain '021 can be successfully introduced into a contaminated soil where it will thrive and poliferate, and that chlorinated hydrocarbons in the soil are significantly removed without chemical induction or introduction of other potentially toxic substances. The Strain '021 is successfully introduced using a system modified from the system disclosed in U.S. Pat. No. 6,464,005 to Mark T. Ellis (Ellis), which is hereby incorporated by reference. The modified method is referred to as Subsurface Metabolism Enhancement—Chlorine or SMECI.)

The original Ellis system, Subsurface Metabolism Enhancement (SME), is designed to remediate hydrocarbon contamination by promoting metabolism by bacteria that already exist the soil. This is done by enhancing the soil environment with oxygen and nutrients, and by withdrawing the metabolic product gasses. The present SMECI system also includes the introduction of Strain '021.

An aspect of the present system is a method for removing chlorinated hydrocarbons from a contaminated soil matrix involves injecting an oxygen-containing gas, a nutrient, and Strain '021, into the contaminated soil matrix below the water table, and extracting gas and vapor from the vadose zone in contaminated soil matrix.

As described below, the nutrients are designed to provide a carbon and energy source, and other metabolic substances for the bacterium, but importantly cometabolites are not required, as the metabolic pathway does not require a trigger by another substance.

The injection is generally done through one or more injection wells or conduits into the contaminated zone in the soil below the water line. The oxygen-containing gas can be air, oxygen, or any suitable gas mixture containing oxygen. Injection of the oxygen-containing gas is continuous.

The flow rate and volume the oxygen containing gas is sufficient to provide a driving force for oxygen entering the soil matrix. The objective is to dissolve the air-borne oxygen in the groundwater, not to disperse gas through the groundwater. Better results will result if the flow rate is regulated to minimize bubbling into the underground water phase. A flow rate that creates bubbling and agitation is believed to lead to disruption of the soil matrix and channeling through the matrix. The result is that the gas and nutrients flow through the matrix to the extraction through bypass channels and do not contact portions of the contaminated soil.

The flow rates and pressures of the present injection are accordingly low enough to provide a drive flow through the existing porosity and permeability of the matrix without forcing new flow channels. This manner of injection with these low flow condition is referred to herein as “Molecular Oxygen Transfer”. Any low flow rate is contemplated that is suitable for the properties of the soil. A flow rate of 5-40 cubic feet per hour (CFH) has been found suitable.

The nutrients contain any suitable carbon source, preferably cheap and readily available. Nutrients also include any other necessary substances required for growth, such as nitrate, and phosphate in suitable proportions. The nutrients can be injected as a solution in batches or continuously through the same or different injection wells as the oxygen-containing gas. The Strain '021 bacteria strain can be mixed into the nutrient solution, or injected in any other suitable manner.

The extraction of gas and vapor from vadose zone is through one or more extraction wells. A vacuum as applied to draw gasses originating in contaminated regions below the water line and in the vadose zone. The gasses include biogenic gasses generated by organism metabolism, and gasses that remain from the oxygen-containing gas.

To direct extraction to the gasses from the contaminated area and avoid surface air from being drawn into the extraction wells, the top surface of vadose zone exposed to the atmosphere is contained, such as by sealing the surface of the soil above the vadose zone. Notwithstanding this precaution, gasses drawn from the surface may be present in the extraction wells, resulting in a higher-extracted gas volume.

### BRIEF DESCRIPTION OF DRAWINGS

FIG. 1 is site map showing installation of a remediation system.

FIG. 2 is a cross-section of the installation of the system of FIG. 1

FIGS. 3A, 3B and 3C are graphs showing PCH and CO₂ values from monitor wells during a remediation test.

### DETAILED DESCRIPTION

### Example

This example describes a test whether the aerobic bacterium Ralstonia eutropha Strain '021 can survive in the natural, subsurface environment and also degrade chlorinated solvents in a contaminated groundwater plume. For this example, a site of a dry-cleaning facility was found where perchloroethylene had been released into the ground over a 50 year period.

An oxygen and nutrient delivery system which was a modified from the SME system to extract chlorinated substance, referred to below as SMECI, was used. The bacterium was injected into two discrete elevations of a contaminated, unconfined aquifer in a three month test. After a period of seven weeks and six injections of the bacterium, the concentration of PCE began to decline in the lower aquifer. By the end of the three month project, the lower aquifer PCE concentration had been reduced by 98%; the upper aquifer PCE concentration had been reduced by 65%.

An area for the test was found behind the shed where perchloroethylene (PCE) was stored and the dumpster, where dry cleaning muck was disposed in the past. Dry cleaning muck is the residual solid waste material that accumulates in the dry cleaning machines. The muck may be contaminated with PCE and may show hazardous characteristics for toxicity.

The previous laboratory tests of R. eutropha described in the Harker papers were with trichloroethene (TCE). No suitable TCE-contaminated site was available, but is was believed that PCE would test the ability of R. eutropha to deal with a solvent that is more densely chlorinated than TCE

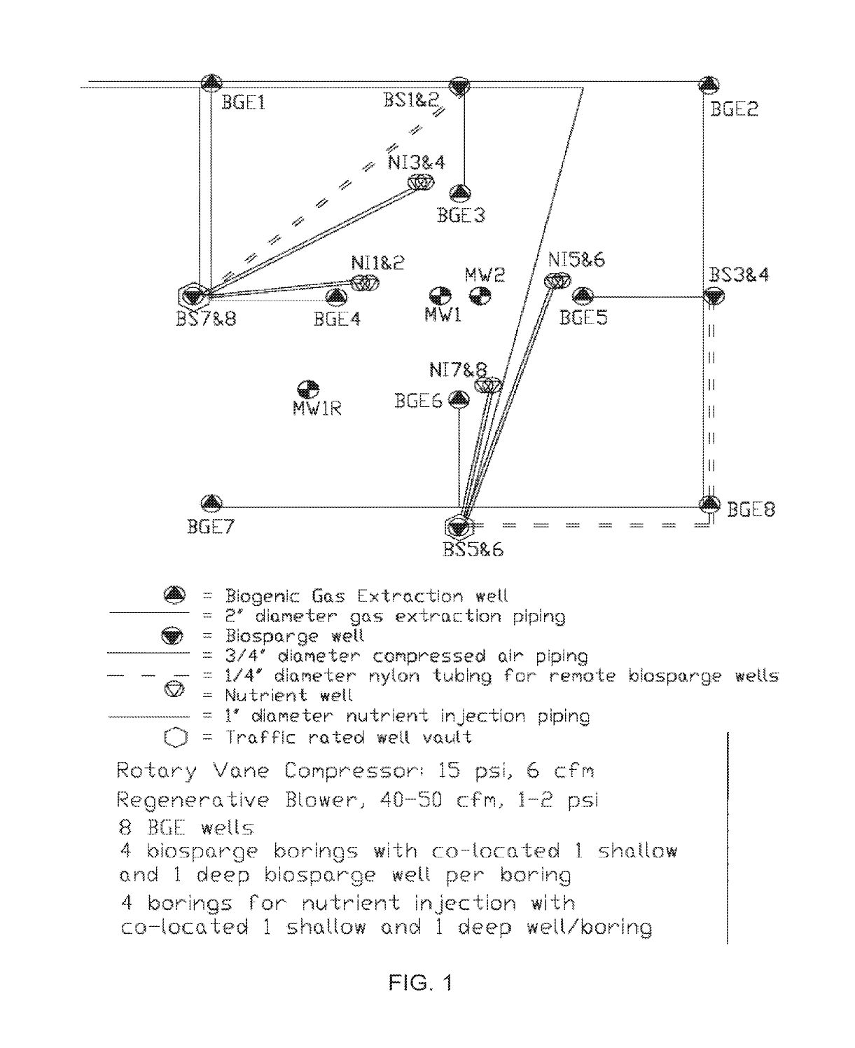

The SMECI system was installed in a 15×15 foot area configured as shown by the site map shown in FIG. 1. The paving was mostly asphalt, with an abandoned sidewalk found under the north portion of the test plot. All of the paving was removed by hand and cutting of large pieces of concrete, and disposed at a landfill.

The installation sequence was as follows:

Day 1 Mar. 25, 2009 Removal of the pavement;
Day 2 drilling of the well borings commences;
Day 3 drilling is completed with 2 monitor wells (MW1, MW2), 8 air injection wells, 8 biogenic gas extraction (BGE) wells and 8 nutrient injection wells; plumbing to connect the BGE wells to the vacuum header commences;
Day 6 groundwater wells are both sampled;
Day 7 plumbing of all the wells is completed; well vaults are concreted into place; SMECI startup is tested and allowed to run full time;
Day 8 Results from Day 6 sampling event shows PCE in shallow well (MW2) at 16 micro g/L and in the deep well (MW1) at <2 micro g/L;
Day 9—paved the SMECI installation with asphalt; injected the first batch of Strain '021 and sodium citrate through the nutrient injection wells.

The SMECI system develops air circulation in the subsurface by injecting air below the water line. To develop the air circulation requires installation of various well types. Wells were drilled using the GeoProbe® push probe system.

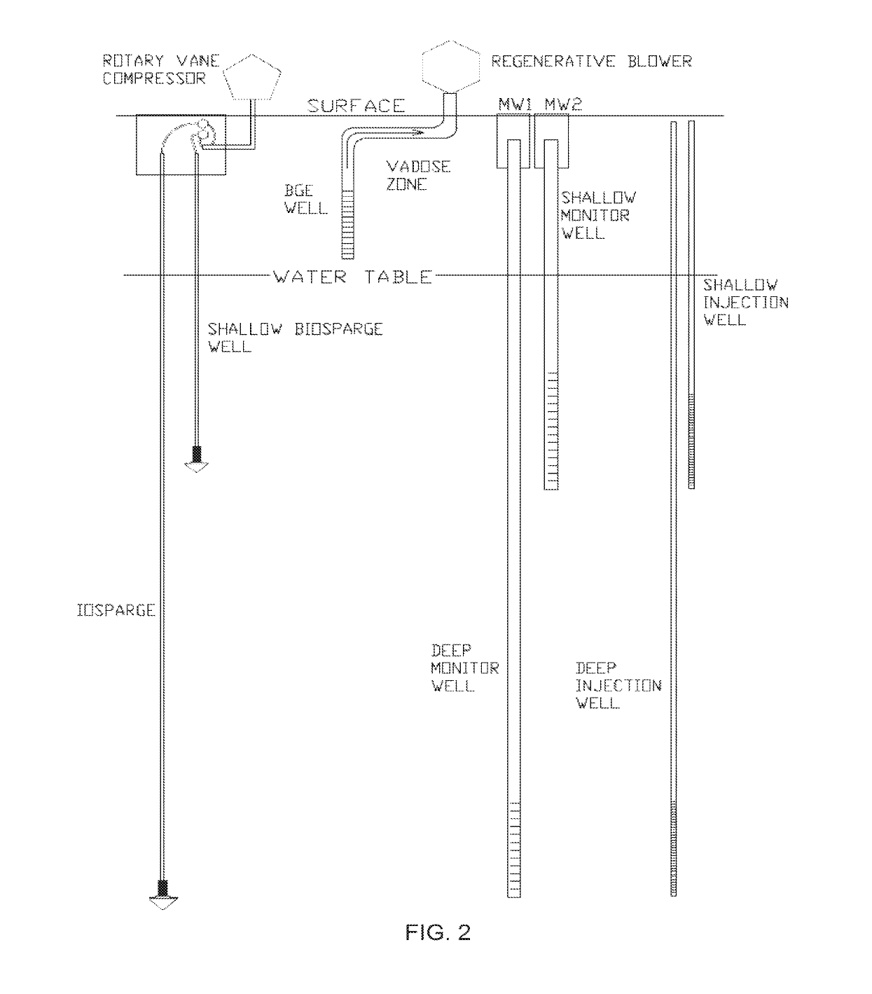

Four types of wells were drilled for this project. Refer to FIGS. 1 and 2 for the plan and side views of the SMECI configuration.

Air injection wells deliver atmospheric air through a Rotary Vane Compressor into the subsurface. The object of the air injection is to aerate the groundwater and saturated soil with oxygen at a natural concentration of approximately 20.9%. Four air injection borings were advanced with the push probe. Each boring was developed with an air injection well set at 29.9 feet below ground surface (bgs) and another set at 15 feet bgs. Refer to FIGS. 1 and 2 showing the configuration of the air injection wells. Four sets of air injection wells assumes at least a twofold redundancy in the number of required air injectors to account for air injectors that may fail to deliver the necessary amount of air. The dual elevation is to examine the upper and lower reaches of the unconfined aquifer.

BGE or Biogenic Gas Extraction wells terminate in the vadose zone and are constructed to remove the volatile CO₂ gas from the metabolism of the solvent. Eight borings were advanced with the push probe to eight feet bgs. Each of the borings was developed into a gas extraction well with five feet of slotting. Refer to FIGS. 1 and 2 showing the configuration of the BGE wells.

Nutrient injection wells were installed to the two depths of study in the aquifer. The injection wells place bacteria and nutrients into the target zones. Four shallow and four deep injection well borings were advanced with the push probe and completed with PVC casing and five feet of slotting. Refer to the attached FIGS. 1 and 2 showing the configuration of the nutrient injection wells.

Monitor wells are established at the two study depths to measure the groundwater chemistry of the unconfined aquifer. The monitor wells use a dedicated sampling tube to collect groundwater at a specific depth. MW1 was advanced to 29.9 feet bgs; MW2 was advanced to 15 feet bgs. The sampling tubes were set at the bottom of each well casing. MW1 silted in and was replaced with MW1R, also advanced to 29.9 feet bgs. Refer to FIGS. 1 and 2, showing the configuration of the monitor wells.

All of the air injection wells operated off from a common header attached to a Gast™ 1.5 HP rotary vane compressor. Compressed air is metered into each air injector with a proprietary flow valve and meter.

The BGE system was powered with a Gast 1HP regenerative blower, connected into vacuum mode. The ideal balance ratio of injected air to extracted air is 1:10. This system generated an average balance ratio of 1:25 injected:extracted air. This value does not affect the activity of the microbes, since they are in the water column and unaffected by the extracted air in the vadose zone. However, the extracted air chemistry was likely compromised and diluted from air-scavenging outside the treatment zone.

Injection of nutrients and bacteria Strain '021 was done manually with a Shurflo® diaphragm pump, rated to 30 PSI. Bacterial injections were diluted with clean well water to assure that the volumes of injected liquid were sufficient to pass through the piping and deliver the bacteria into the formation. Clean well water was used to purge out the piping following an injection of the bacteria. Nutrients were likewise injected in dissolved phase and injected with the pump, then the piping was purged to assure that the nutrients did not remain in the piping, but were delivered to the formation.

Batches of R. eutropha Strain '021 were cultured under laboratory conditions as described in the above Harker papers, and provided in volumes of one gallon or four liters. The mixed units were a function of the container used to transport the bacteria; sometimes one gallon milk jugs were used and sometimes plastic totes with liter-volumes were used. The sodium citrate nutrient was added as a carbon source for Strain '021 with most batches, but separated by clean water between injections to avoid shocking the bacteria. Injection schedules are shown in TABLE 1.

Nitrogen and phosphorus nutrients were added to stimulate the development of cellular mass. Nitrogen was provided by agricultural grade ammonium sulfate fertilizer (24-0-0). Phosphorus was provided in the form of agricultural super treble phosphate (0-46-0).

Groundwater samples were collected from each of the two monitor wells using ⅜ inch diameter, polyethylene tubing, dedicated to each well. The samples were retrieved from the tubing using a peristaltic pump. The groundwater was pumped during all field and laboratory sampling. Typically, 2 to 4 gallons of groundwater were pumped out of each well during a sampling event. The groundwater was disposed on the site, within the influence of the SMECI system.

Groundwater was analyzed by American West Analytical Laboratories for total chlorinated organics (TOX, methods 8260B/5030C) and total organic carbon (TOC, method A5310B). Field measurements from each monitor well were collected for pH, Temperature ° F., Dissolved Oxygen mg/L, nitrate as NO3- and ortho phosphate as PO4. Field measurements were determined using a Hach® Company Limnology kit. Sampling protocols were followed according to training through the Groundwater and Soil Sampler certification of the Division of Environmental Response and Remediation. Air samples were collected from the BGE emission stack. Samples were generally analyzed with a metal catalyst vapor detector, identified as the Eagle meter. The Eagle Portable Gas Detector is electrical resistance device manufactured by RKI Instruments, Inc. The Eagle measures LEL ranging from 0-100%, Hydrocarbons from 0-50,000 ppm as hexane, Oxygen from 0-40%, Carbon dioxide from 0-5%. Hydrocarbons are calibrated with 40,000 ppm hexane and zeroed with background air or with hydrocarbon-free nitrogen.

Samples were analyzed for Oxygen, Volatile Organic Compounds and CO₂.

### DISCUSSION

A soil characterization sample was collected from the site at the north end of the property, just east of the compressor shed. The soil sample analysis showed 600 micro-g/kg PCE. The property had been used as a dry cleaner for 50 years. It is reasonable to assume that finding any PCE on site would indicate the potential for a significant groundwater plume. PCE is heavier than water and will migrate vertically to the water table, then to bottom of the aquifer to the confining layer. The SMECI system was planned for the area just off the east side of the compressor building, directly south of where the soil sample was collected.

As the aquifer oxygenated, the PCE that was adsorbed to the soil particles de-bonded and dissolved. Increases in the concentration of PCE could be attributed to this mechanism for some of the dissolved PCE, but other PCE was unintentionally added through the rotary vane compressor feeding the air injection wells. The intake air for the compressor was installed inside the shed, according to normal installation protocol. In this case, the shed was storing PCE and open containers containing PCE contaminated waste. Volatilized PCE was drawn into the compressor and likely contaminating the aquifer. The compressor intake was moved to the outside of the compressor shed, providing clean air to the air injection wells. This assured that no PCE injection through the air injection wells would continue.

Groundwater dissolved oxygen was measured using the modified Winkler titration method of Hach Chemical Company. Groundwater oxygen measurements started on Apr. 30, 2009. Dissolved oxygen in MW1/R ranged from 3 to 7 mg/L, averaging 5 mg/L. Dissolved oxygen in MW2 ranged from 6 to 8, averaging 6.8 mg/L. Refer to TABLE 2 for a summary of the data.

Total Organic Carbon was measured to assure that the injection of sodium citrate did not increase the TOC beyond 10 mg/L

MW1 silted in at a rate of 4 inches per week. After seven weeks of operation, MW1 was abandoned by filling the casing with bentonite pellets. MW1R was advanced to the same depth, 29.9 feet bgs. Minor siltation was experienced with MW1R.

### Observations

Groundwater removed from MW1/R was consistently turbid, while the groundwater from MW2 was consistently clean. This is probably due to an increase in the activity of the deep air injection wells over the number of operating air injection wells at the shallower elevation. The redundancy built into the Air Injection portion of the system was probably excessive for the size of the test site.

Excepting the first agar dish sample collected on Day 13, all of the agar dishes showed bacterial colonies. The agar in each dish was treated with two separate antibiotics with the intent of screening out all microbes not immune to the effects of those antibiotics. R. eutropha is immune to both antibiotics. In theory, the treated agar selects for the R. eutropha; however, finding other colonies on the samples provides an insight into microbial competition in the test area. Refer to the photos of the agar dishes and the relative abundance assessment on each well's sample. The assessment of abundance is meant as a simple means of evaluating the success of the R. eutropha Strain '021 population at each sampling event. The deep well, MW1/R showed consistent abundant populations, while the populations in the shallower MW2 were generally sparse. Refer to TABLE 2 for the frequency of bacterial sampling.

SMECI apparently is able to sustain the Strain '021 populations along with other, native colonies of microbes that were found on the agar dishes. Some competition for available carbon compounds would be expected with native microbial communities. Although there are no quantitative data developed for this test, the diversity of microbial types appeared to be lower in the deeper well.

The concentrations of PCE were significantly degraded, in both the shallow and deep portions of the unconfined aquifer. Measuring from the highest recorded concentrations to the last collected concentration of PCE, the PCE gross reduction in MW1 was an astounding 98.5%, achieved in 7 weeks. The rapid rate of degradation especially in the lower reaches of the aquifer indicate that this strategy for remediation of PCE plumes is particularly effective.

The gross reduction of PCE in MW2 was more modest, but still achieved 69.6% reduction in 5 weeks.

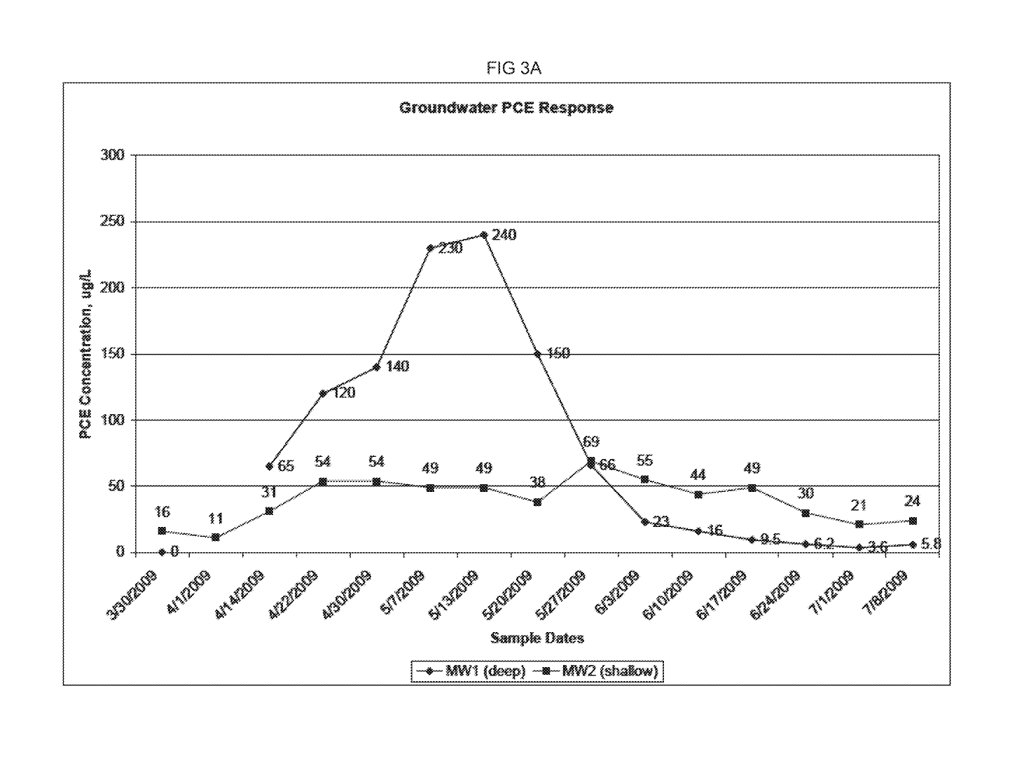

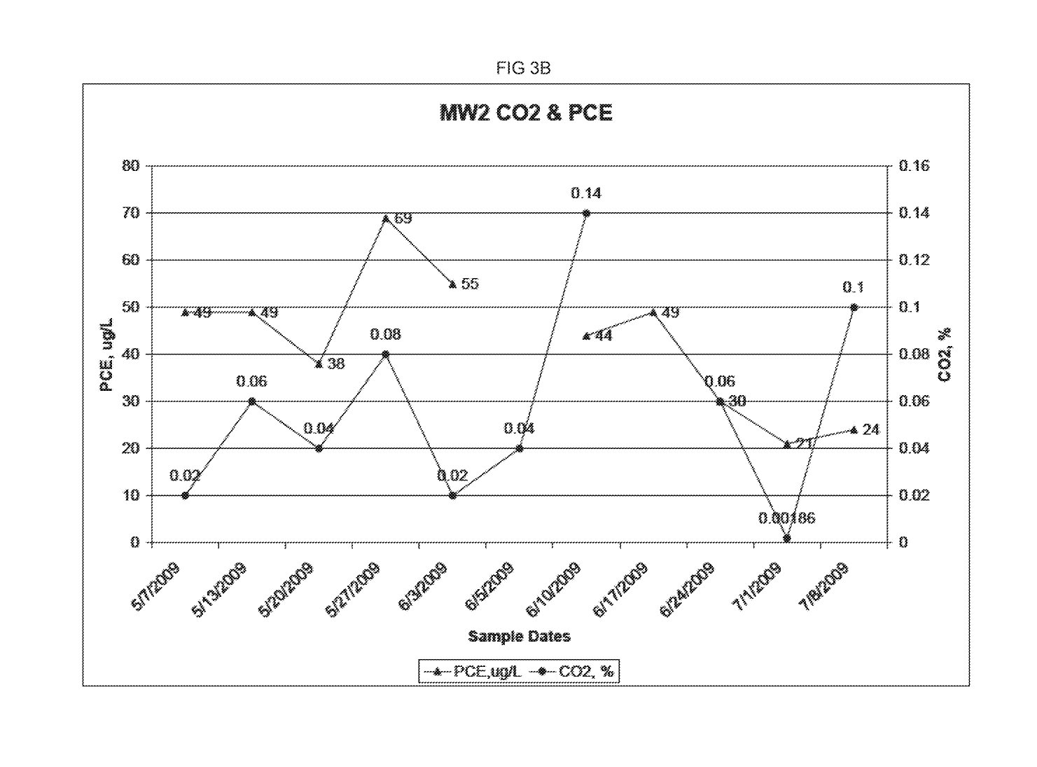

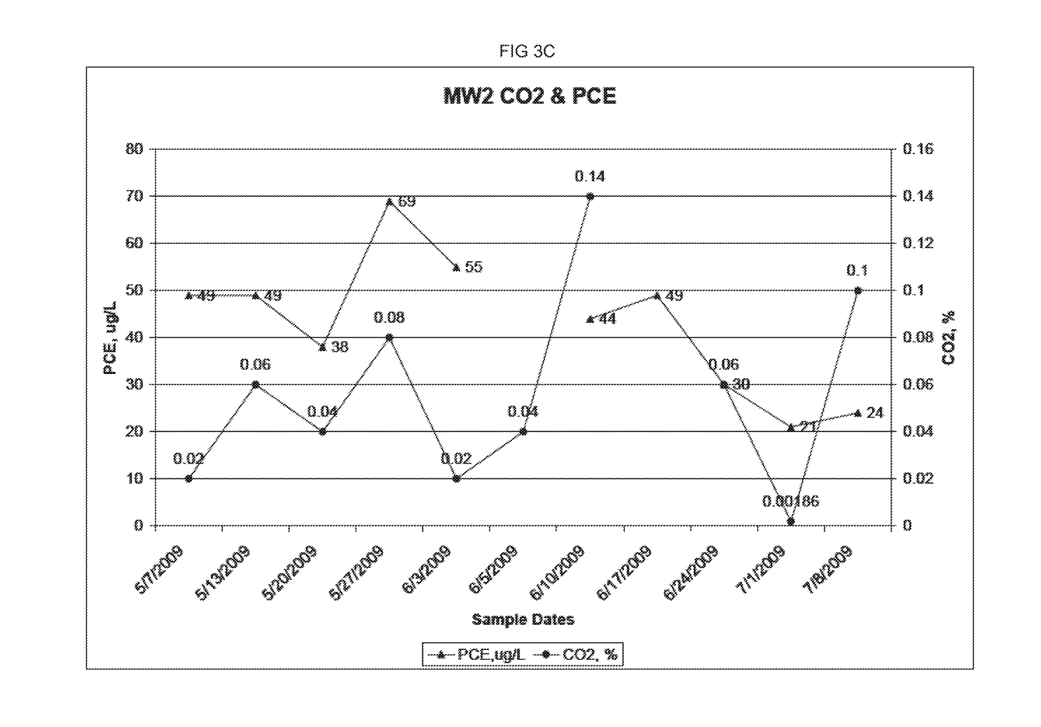

There was a slight rebound in the PCE concentration of both wells at the finish date of the test, Day 106. Calculating the percent PCE reduction for the wells through the rebound still provides 98% reduction of PCE in MW1R and 65% reduction in MW2. The rebound could be indication of asymptotic conditions, but is more likely a result of laboratory range of error. Accuracy in analyzing PCE in water lies between 49 and 163% for 99% of profiles according to Kyle Gross, manager of American West Analytical Laboratories. Both rebound values fall within the high end of the accuracy range for the test method. One cannot ignore the fact that the PCE source has not been stopped, so the rebound may also be the result of more PCE input to the subsurface. This is substantiated by the sudden spike of CO₂ in the BGE well that accompanied the rebound, refer to the graphs in FIGS. 3A, 3B, and 3C, which show PCE concentration in the MW1 and MW2 wells, and CO₂ and PCE concentration from MW1, and MW2 sample wells, respectively.

CO₂ generated by the metabolism of PCE is apparent in the readings of the BGE stack emissions. During the peak of biological activity, the concentrations of CO₂ increased, as expected. Since there was an unbalanced input:output air ratio, the stack gases were significantly diluted, making them harder to detect. The SMECI system generally relies on oxygen depression for calculation of removed hydrocarbon mass. With this test, the mass of solvent was insufficient to induce much of an oxygen depression. The Eagle™ meter reads oxygen down to one decimal. The Eagle meter reads CO₂ to two decimals, so its readings were used to evaluate metabolism. Sufficient variability was observed in the stack gases that metabolism was definitely the cause of the decline in PCE values. Refer to the gas readings in TABLE 3.

### Findings

R. eutropha survives in the subsurface environment. The test showed that the populations of R. eutropha thrived in the deeper environment, whereas the shallower populations seemed to struggle.

SMECI as a delivery system was successful in promoting the growth of R eutropha in two separate zones of the unconfined aquifer.

The combination of SMECI and R. eutropha Strain '021 shows very rapid degradation of PCE in the subsurface. The bacterium was originally tested on TCE; it is likely that the bacterium will degrade other chlorinated solvents.

The test was budgeted for only three months, but a significant amount of practical information was obtained. These findings indicate a very likely commercial use of Strain '021 with the SMECI delivery system for remediating some of the toughest subsurface environments.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

TABLE 1
Injection materials into the test SME system,
Payless Dry Cleaner, Murray, UT.

| | # of | Vol. | Sodium | Ammonium | Phosphate, |
|---|---|---|---|---|---|
| Date | wells | Bacteria | Citrate, gr | Sulfate, lbs | lbs |
| Apr. 2, 2009 | 6 | 4 L | 600 | | |
| Apr. 8, 2009 | 6 | | 600 | | |
| Apr. 11, 2009 | 6 | 1 gal | | | |
| Apr. 30, 2009 | 4 | | 400 | | |
| May 13, 2009 | 4 | 1 gal | 400 | | |
| May 20, 2009 | 4 | 4 L | 400 | | |
| May 27, 2009 | 4 | 4 L | 300 | | |
| Jun. 3, 2009 | 8 | 4 L | 800 | 4 | 2 |
| Jun. 5, 2009 | 8 | 4 L | | | |
| Jun. 24, 2009 | 7 | 4 L | 800 | 2* | |

“*” indicates deep well only.

TABLE 2
Field data collected with the Hach Limnology kit, units as noted. Plating
refers to collecting a bacterial sample onto the agar dishes.

| Monitor Well | Date | Temperature, F. | pH | D.O., mg/L | NO3, mg/L | PO4, mg/L | Plating |
|---|---|---|---|---|---|---|---|
| MW1 | Apr. 6, 2009 | | | | | | xxx |
| | Apr. 14, 2009 | | | | | | xxx |
| | Apr. 22, 2009 | | | | | | xxx |
| | Apr. 30, 2009 | 62 | 8.1 | 5 | | | xxx |
| | May 7, 2009 | 60 | 7.6 | 5 | | | xxx |
| | May 13, 2009 | 60 | 7.8 | 6 | | | xxx |
| MW1 replaced with MW1R | | | | | | | |
| MW1R | May 20, 2009 | 62 | 7.5 | 3 | | | xxx |
| | May 27, 2009 | 62 | 7.8 | 7 | | | xxx |
| | Jun. 3, 2009 | 62 | 7.8 | 6 | nd | | xxx |
| | Jun. 5, 2009 | | | 5 | | | |
| | Jun. 10, 2009 | 60 | 7.6 | 5 | 0.176 | 0.18 | xxx |
| | Jun. 17, 2009 | 62 | 7.8 | 5 | nd | 0.44 | xxx |
| | Jun. 24, 2009 | 64 | 7.7 | 3 | nd | 0.3 | xxx |
| | Jul. 1, 2009 | 64 | 7.5 | 3 | 0.088 | 0.94 | xxx |
| | Jul. 8, 2009 | 62 | 7.8 | 7 | 0.176 | 0.16 | xxx |
| MW2 | Apr. 6, 2009 | | | | | | xxx |
| | Apr. 14, 2009 | | | | | | xxx |
| | Apr. 22, 2009 | | | | | | xxx |
| | Apr. 30, 2009 | 58 | 7.5 | 6 | | | xxx |
| | May 7, 2009 | 59 | 7.4 | 7 | | | xxx |
| | May 13, 2009 | 59 | 7.3 | 8 | | | xxx |
| | May 20, 2009 | 60 | 7.7 | 6 | | | xxx |
| | May 27, 2009 | 59 | 7.6 | 7 | | | xxx |
| | Jun. 3, 2009 | 62 | 7.7 | 7 | 3.96 | | xxx |
| | Jun. 5, 2009 | | | 8 | | | |
| | Jun. 10, 2009 | 58 | 7.7 | 7 | 3.96 | 0.12 | xxx |
| | Jun. 17, 2009 | 60 | 7.5 | 6 | nm | 0.46 | xxx |
| | Jun. 24, 2009 | 62 | 7.5 | 7 | 4.4 | 0.18 | xxx |
| | Jul. 1, 2009 | 62 | 7.7 | 8 | 3.08 | 0.74 | xxx |
| | Jul. 8, 2009 | 62 | 7.5 | 6 | 8.8 | 0.4 | xxx |

“nd” means not detected.
“nm” means not measured.

TABLE 3
BGE stack measurements, units as indicated.

| Stack | Date | VOC, ppm | O2, % | CO2, % | Flow, cfm | air flow device | Vapor Meter |
|---|---|---|---|---|---|---|---|
| BGE | May 7, 2009 | 50 | 20.9 | 0.02 | nm | | Eagle meter |
| | May 13,2009 | 15 | 20.9 | 0.06 | 43 | Kurz | Eagle meter |
| | May 20, 2009 | 0 | 20.9 | 0.04 | 49 | Kurz | Eagle meter |
| | May 27, 2009 | 0 | 20.9 | 0.08 | 60 | Rotron | Eagle meter |
| | Jun. 3, 2009 | 0 | 20.9 | 0.02 | 60 | Rotron | Eagle meter |
| | Jun. 5, 2009 | 0 | 20.9 | 0.04 | nm | | Eagle meter |
| | Jun. 10, 2009 | 0 | 20.9 | 0.14 | nm | | Eagle meter |
| meter failed | Jun. 17, 2009 | | | | nm | | Eagle meter |
| | Jun. 24, 2009 | 0 | 20.9 | 0.06 | nm | | Eagle meter |
| | Jul. 1, 2009 | nm | nm | 0.00186 | nm | | SME sensor |
| | Jul. 8, 2009 | 35 | 20.3 | 0.10 | 39 | Kurz | borrowedEagle |

“nm” means not measured.

What is claimed is:

1. A method for remediating contaminated soil containing chlorinated hydrocarbons under a water table comprising:
injecting below the water table an oxygen-containing gas under conditions to dissolve oxygen into the water table;
introducing nutrients below the water table;
introducing Ralstonia eutropha bacteria with a non-cometabolic pathway for metabolizing chlorinated hydrocarbons below the water table to directly and non-inductively metabolize the chlorinated hydrocarbons as a non-cometabolic substrate;
extracting gas the in a vadose zone above the water table that is derived from metabolism of the strain of Ralstonia eutropha bacteria with the chlorinated hydrocarbons.

2. A method as in claim 1 wherein the chlorinated hydrocarbons include chlorinated ethenes.

3. A method as in claim 1 wherein the chlorinated hydrocarbons include one or more of trichloroethylene, and perchloroethylene.

4. A method as in claim 1 wherein the Ralstonia eutropha with a non-cometabolic pathway for metabolizing chlorinated hydrocarbons include Ralstonia eutropha AEK301/pyk3021.

5. The method of claim 1 wherein the injecting below the water table an oxygen-containing gas comprises injecting air at a low-flow injection rate to sufficient to dissolve molecular oxygen in the water table, and to and provide a drive flow through the existing porosity and permeability of the matrix without forcing new flow channels.

6. The method of claim 1 wherein the strain of Ralstonia eutropha bacteria and the nutrients are injected together below the water table.

7. A system for remediating contaminated soil containing chlorinated hydrocarbons under a water table comprising;
air injection wells for injection an oxygen-containing gas under the water table,
biogenic gas extraction wells for extracting from a vadose zone above the water table gas generated from metabolism of bacteria and the chlorinated hydrocarbons,
nutrient injection wells for injecting nutrient and Ralstonia eutropha bacteria with a non-cometabolic pathway for metabolizing chlorinated hydrocarbons below the water table.

8. A system as in claim 7 wherein the contaminated soil contains chlorinated ethenes.

9. A system as in claim 7 wherein the contaminated soil contains trichloroethylene, and perchloroethylene.

10. A system as in claim 7 wherein the Ralstonia eutropha with a non-cometabolic pathway for metabolizing chlorinated hydrocarbons include Ralstonia eutropha AEK301/pyk3021.

11. The system of claim 7 wherein the injection wells for injection an oxygen-containing gas under the water table inject air at a low-flow injection rate to sufficient to dissolve molecular oxygen in the water table, and to and provide a drive flow through the existing porosity and permeability of the matrix without forcing new flow channels.

12. The system of claim 7 wherein the nutrient injection wells inject the strain of Ralstonia eutropha bacteria and the nutrients together below the water table.
